(19) United States
(12) Patent Application Publication
(10) Pub. No.: US 2012/0057656 A1
(43) Pub. Date: Mar. 8, 2012

(54) METHOD AND APPARATUS FOR PASSIVE RADIO FREQUENCY INDENTIFICATION (RFID) READER DIGITAL DEMODULATION FOR MANCHESTER SUBCARRIER SIGNAL

(76) Inventors: Ji Hoon BAE, Daejeon (KR); Dong Han LEE, Daejeon (KR)

(21) Appl. No.: 13/225,949

(22) Filed: Sep. 6, 2011

(30) Foreign Application Priority Data
Sep. 8, 2010 (KR) 10-2010-0087830

(51) Int. Cl. H04L 25/06

(52) U.S. Cl. 375/319

(57) ABSTRACT

An apparatus and method for passive radio frequency identification (RFID) reader digital demodulation with respect to a Manchester subcarrier signal are disclosed. In a passive RFID environment where the Manchester subcarrier signal contains DC components in a frequency region, even when a tag signal containing the DC offset noise is input to a baseband, demodulation may be efficiently performed while the DC offset noise is removed. Therefore, accurate detection of tag information from the tag signal may be achieved.

### CROSS-REFERENCE TO RELATED APPLICATION

This application claims the benefit of Korean Patent Application No. 10-2010-0087830, filed on Sep. 8, 2010, in the Korean Intellectual Property Office, the disclosure of which is incorporated herein by reference.

### BACKGROUND

1. Field of the Invention

The present invention relates to a method of effectively removing, from a tag signal distorted by the DC offset noise, a direct current (DC) offset noise generated from a baseband of a receiving end of a passive radio frequency identification (RFID) demodulation apparatus.

2. Description of the Related Art

Generally, according to a radio-frequency identification (RFID) scheme, information is extracted from or written on an RFID tag which contains specific ID information, without physical contact using a wireless frequency, thereby enabling recognition, tracking, and management of an object, an animal, a person, and the like attached with the RFID tag.

An RFID system using the RFID scheme is achieved using a plurality of RFID tags, for example, electronic tags or transponders, each containing specific ID information and being attached to an object or an animal, and an RFID reader or interrogator for reading and writing of the ID information of the tags. The RFID systems may be classified into a mutual induction type and an electromagnetic wave type depending on a communication method between the RFID reader and the RFID tag. Also, the RFID systems may be classified into an active type and a passive type depending on whether the RFID tag is powered by an integrated power source or by the RFID reader or interrogator. Depending on used frequency, the RFID system may also be classified into a long wave type, a medium wave type, a short wave type, and an ultra-short wave type.

Application of the RFID scheme has been gradually expanding from identification in pallet or box units to identification by an individual article unit. Presently, international standardization of ISO/IEC 18000-3 Mode 3 (HF Gen2) is ongoing, which is for applying a high performance Gen2 protocol of an ultra high frequency (UHF) band to an HF band appropriate for metal and liquid environments. In accordance with the HF Gen2 standards, a Manchester subcarrier method and a Miller subcarrier method are used for subcarrier signaling from the RFID tag to the RFID reader.

FIG. 1 is a graph illustrating a symbol signal shape according to the Manchester subcarrier method.

Referring to FIG. 1, the Manchester subcarrier type symbol signal includes a section having four subcarrier cycles 110 or two subcarrier cycles 120 depending on a value M within a half period, and a section having a rectangular pulse which does not contain the subcarrier cycle.

That is, according to the Manchester subcarrier method, different from the Miller subcarrier method, a frequency region includes a considerable amount of direct current (DC) components and low frequency components.

FIG. 2 shows frequency-signal level graphs in a frequency spectrum according to the conventional Manchester subcarrier method.

FIG. 2 shows a frequency spectrum 210 of a Manchester subcarrier signal with a subcarrier frequency of about 424 KHz and two subcarrier cycles, and a frequency spectrum 220 of a Manchester subcarrier signal with a subcarrier frequency of the same frequency, that is, about 424 KHz and four subcarrier cycles.

Therefore, the RFID reader that communicates with the RFID tag by magnetic coupling in an HF band needs to be equipped with both a transmitter and a receiver and perform both transmission and reception with one antenna. For example, when the RFID reader communicates with the RFID tag using a great amount of output power, a DC offset noise may be generated in a baseband signal output through amplitude shift keying (ASK) demodulation to remove carriers of 13.56 MHz from an RF/analog unit of a receiving end. Here, even though the received tag signal includes subcarrier components, when DC components are also included, the demodulation performance may be greatly reduced due to a DC offset noise.

FIG. 3 is a time-signal level graph illustrating a tag signal distorted by a DC offset noise, according to a conventional art.

Referring to FIG. 3, a Manchester subcarrier signal contains DC components in a frequency region in the similar manner as in FIG. 2. When the Manchester subcarrier signal is thus distorted by the DC offset noise and the tag signal is demodulated using a conventional receiver, when a minor DC offset exists in a baseband of a receiving end of the RFID reader, performance of detecting tag information from the baseband is reduced. Accordingly, extract useful tag information becomes difficult.

Accordingly, there is a desire for a method for effectively removing DC offset noise from a tag signal.

### SUMMARY

An aspect of the present invention provides an apparatus and method for a passive radio frequency identification (RFID) reader digital demodulation with respect to a Manchester subcarrier signal, the apparatus and method capable of restoring a tag signal more accurately even when the tag signal such as the Manchester subcarrier signal, which contains DC components in a frequency region, is distorted due to a DC offset noise, by efficiently demodulating the tag signal and removing the DC offset noise.

According to an aspect of the present invention, there is provided a radio frequency identification (RFID) reader digital demodulation apparatus including a subcarrier digital demodulator to receive a tag signal containing tag information regarding an object attached with an RFID tag, to remove a rectangular pulse within a first half-period of a symbol contained in the received tag signal, and to remove a subcarrier cycle within a second half-period; and a direct current (DC) offset remover to remove DC offset noise from the tag signal from which the subcarrier cycle is removed, using a matched filter.

The subcarrier digital demodulator may include a rectangular waveform remover to remove a rectangular pulse not containing the subcarrier cycle within the first half-period of the symbol contained in the received tag signal; and a subcarrier cycle remover to remove the subcarrier cycle within the second half-period of the symbol contained in the received tag signal.

The subcarrier cycle remover may include a rectangular-pulse-type filter to remove the subcarrier cycle having a selected period within the second half-period of the symbol contained in the received tag signal; and a level determiner to remove a low noise of the tag signal from which the subcarrier cycle is removed, using a reference level value extracted from a level extractor or a selected fixed level value.

The rectangular waveform remover may include a subcarrier-cycle-type filter to remove the rectangular pulse not containing the subcarrier cycle having a selected period within the first half-period of the symbol contained in the received tag signal; and a level determiner to remove a low noise of the tag signal from which the rectangular pulse is removed, using a reference level value extracted from a level extractor or a selected fixed level value.

The rectangular waveform remover may include an absolute value generator to generate an absolute value using the tag signal from which the rectangular pulse is removed; and a gain controller to maintain a level of the tag signal output from the level determiner at a high level or a low level of a first baseband signal generated by a low pass filter.

The subcarrier digital demodulator may include an adder to obtain a sum signal of a signal output from the subcarrier cycle remover and a signal output from the rectangular waveform remover; a low pass filter to generate a first baseband signal from a signal output from the adder; and a level extractor to extract a reference level value in a preamble section of the received tag signal.

The low pass filter may have a structure of a cascade moving average filter.

The level extractor may supply the extracted reference level value to the subcarrier cycle remover and the rectangular waveform remover.

The subcarrier digital demodulator may include a 2-step decimation filter adapted to remove white Gaussian noise from the received tag signal.

The DC offset remover may include a matched filter to match the tag signal with characteristics of the tag signal and output the matched tag signal; an absolute value generator to generate an absolute value with respect to the output tag signal and output the absolute value; a peak position detector to detect a peak position of the tag signal using the output absolute value; and a regenerator to regenerate a second baseband signal with a transistor-transistor-logic (TTL) level, the second baseband signal from which the DC offset noise is removed, using the detected peak position.

The matched filter may have a Manchester basic signal form.

The DC offset remover may generate a peak signal from which DC offset noise is removed, using the matched filter and the absolute value generator.

The peak position detector may generate an edge clock using the detected peak position.

The RFID reader digital demodulation apparatus may further include a symbol determiner to extract the tag information by decoding the tag signal demodulated by the subcarrier digital demodulator.

According to another aspect of the present invention, there is provided a radio frequency identification (RFID) reader digital demodulation method including receiving a tag signal containing tag information regarding an object attached with an RFID tag; removing a rectangular pulse within a first half-period of a symbol contained in the received tag signal; removing a subcarrier cycle within a second half-period; and removing DC offset noise from the tag signal from which the subcarrier cycle and the rectangular pulse are removed, using a matched filter.

### EFFECT

According to embodiments of the present invention, in a passive radio frequency identification (RFID) environment where a direct current (DC) offset noise may exist in a Manchester subcarrier signal containing DC components in a frequency region, even though a tag signal containing the DC offset noise is input to a baseband, demodulation may be efficiently performed while the DC offset noise is removed. Therefore, accurate detection of tag information from the tag signal may be achieved.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a graph illustrating a symbol signal shape according to a conventional Manchester subcarrier method;

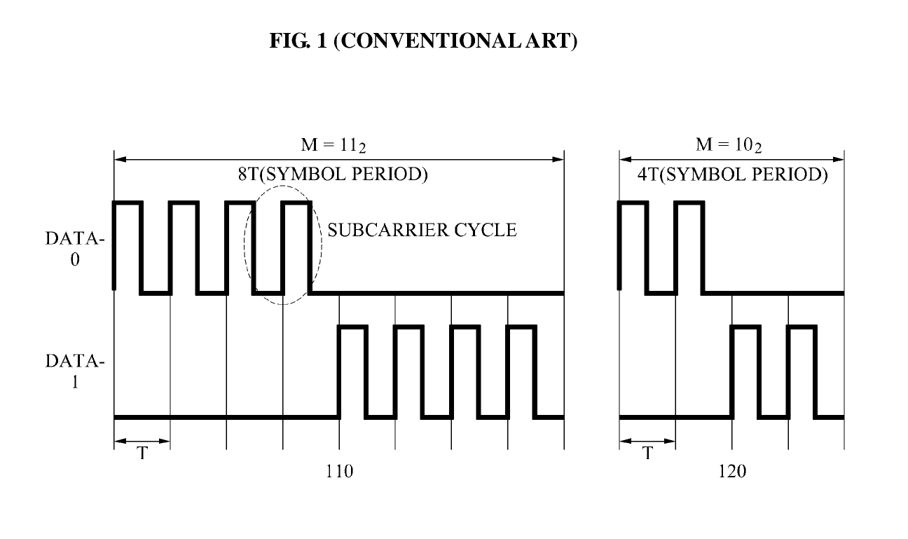

FIG. 2 shows frequency-signal level graphs in a frequency spectrum according to the conventional Manchester subcarrier method;

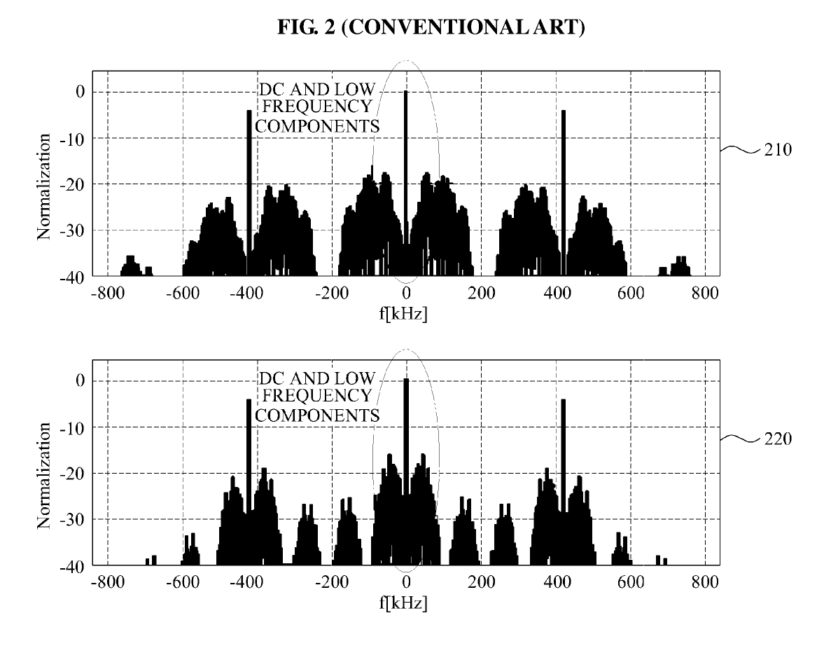

FIG. 3 is a time-signal level graph illustrating a tag signal distorted by a DC offset noise, according to a conventional art;

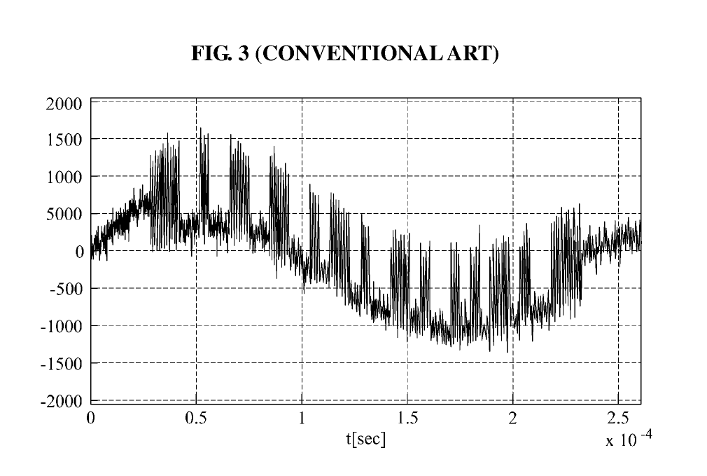

FIG. 4 is a block diagram illustrating a structure of a passive RFID reader digital demodulation apparatus with respect to a Manchester subcarrier signal, according to an embodiment of the present invention;

FIG. 5 is a block diagram illustrating a structure of a 2-stage decimation filter included in an RFID reader digital demodulation apparatus;

FIG. 6 shows graphs illustrating a tag signal which is a 848 KHz Manchester subcarrier signal output by a 2-stage decimation filter;

FIG. 7 is a diagram illustrating a structure of a rectangular waveform remover of an RFID reader digital demodulation apparatus;

FIG. 8 is a diagram illustrating two rectangular waveform removers having different pulse widths;

FIG. 9 shows graphs illustrating a tag signal which is a Manchester subcarrier signal having four subcarrier cycles output through a rectangular waveform remover;

FIG. 10 shows graphs illustrating a tag signal which is a Manchester subcarrier signal having four subcarrier cycles which is passed through a 2-stage decimation filter and output through a rectangular waveform remover;

FIG. 11 is a diagram illustrating a structure of a subcarrier cycle remover of an RFID reader digital demodulation apparatus;

FIG. 12 is a diagram illustrating two subcarrier cycle removers having different pulse widths;

FIG. 13 shows graphs illustrating a tag signal which is a Manchester subcarrier signal having four subcarrier cycles, which is passed through a 2-stage decimation filter and output through a subcarrier cycle remover;

FIG. 14 shows graphs illustrating a first baseband signal;

FIG. 15 is a diagram illustrating a structure of a low pass filter embodied by a cascade moving average filter;

FIG. 16 is a diagram illustrating a structure of a matched filter constituting a DC offset remover of an RFID reader digital demodulation apparatus;

FIG. 17 shows graphs illustrating a tag signal containing a DC offset noise, output through respective units;

FIG. 18 shows graphs respectively illustrating a peak signal, an edge clock, and a second baseband signal;

FIG. 19 is a flowchart illustrating an algorithm to extract a peak position through a peak position detector;

FIG. 20 is a flowchart illustrating a method of RFID reader digital demodulation, according to an embodiment of the present invention;

FIG. 21 is a diagram illustrating a structure of a passive RFID reader digital demodulation apparatus with respect to a Manchester subcarrier signal, according to another embodiment of the present invention;

FIG. 22 shows graphs illustrating a tag signal output from the passive RFID reader digital demodulation apparatus of FIG. 21; and

FIG. 23 shows graphs illustrating a first baseband signal output from the passive RFID reader digital demodulation apparatus of FIG. 21.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

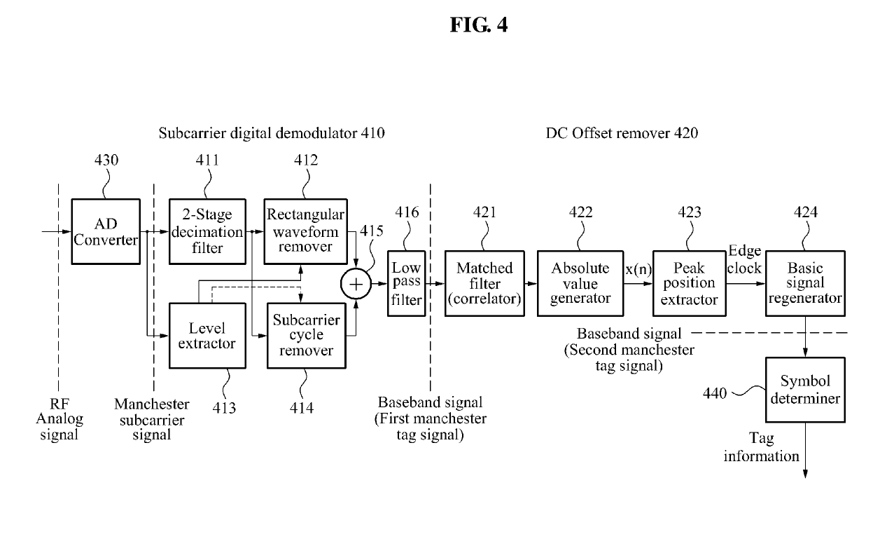

FIG. 4 is a block diagram illustrating a structure of a passive radio frequency identification (RFID) reader digital demodulation apparatus 400 with respect to a Manchester subcarrier signal, according to an embodiment of the present invention.

Referring to FIG. 4, the passive RFID reader digital demodulation apparatus 400, hereinafter, referred to as ‘RFID reader digital demodulation apparatus’, includes an RF/analog amplitude shift keying (ASK) demodulator (not shown), a subcarrier digital demodulator 410, a direct current (DC) offset remover 420, an analog/digital (A/D) converter 430, and a symbol determiner 440.

The subcarrier digital demodulator 410 may receive a tag signal containing tag information regarding an object attached with an RFID tag, remove a rectangular pulse within a first half-period where a subcarrier cycle does not exist, and remove the subcarrier cycle within a second half-period. In other words, the subcarrier digital demodulator 410 may generate a first baseband signal by removing the subcarrier cycle from the tag signal being input from the A/D converter 430.

When the symbol of the received tag signal is 1, the subcarrier digital demodulator 410 may remove a rectangular pulse within the first half-period where the subcarrier cycle does not exist. When the symbol is 0, the subcarrier digital demodulator 410 may remove a rectangular pulse within the second half-period where the subcarrier cycle does not exist.

Here, a half-period of the symbol may be defined as the first half-period and, in this case, the other half-period of the symbol may be defined as the second half-period. Therefore, when the symbol of the Manchester subcarrier signal is 0, the subcarrier cycle exists in the first half-period. When the symbol of the Manchester subcarrier signal is 1, the subcarrier cycle exists in the second half-period. Hereinafter, the demodulation apparatus will be described with reference to a case where the symbol is 1.

For this purpose, the subcarrier digital demodulator 410 may include a 2-stage decimation filter 411, a rectangular waveform remover 412, a level extractor 413, a subcarrier cycle remover 414, an adder 415, and a low pass filter 416.

The 2-stage decimation filter 411 is a low pass filter adapted to remove white Gaussian noise contained in the tag signal having a subcarrier frequency of about 424 KHz or 848 KHz. The 2-stage decimation filter 411 filters off the white Gaussian noise from the tag signal by limiting a band of the received tag signal.

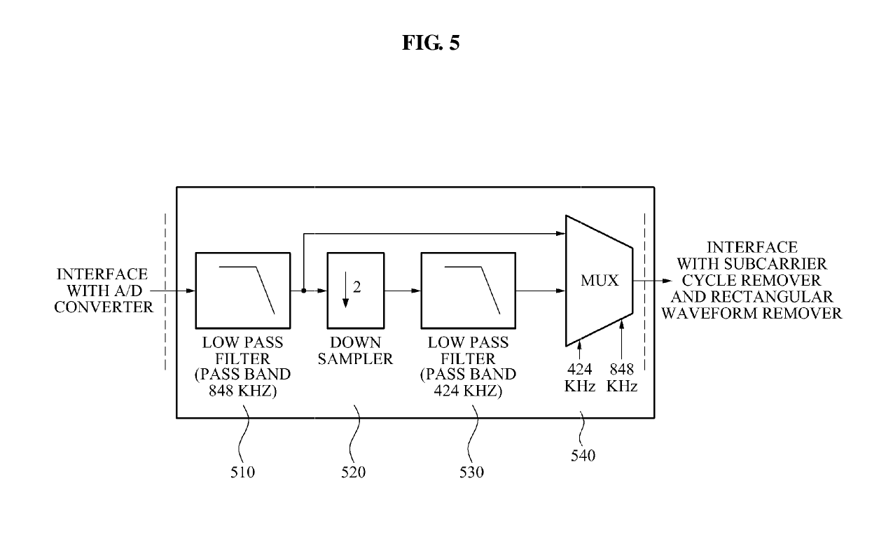

FIG. 5 is a block diagram illustrating a structure of a 2-stage decimation filter 500 included in an RFID reader digital demodulation apparatus.

Referring to FIG. 5, the 2-stage decimation filter 500 includes a low pass filter 501, a down sampler 520, a low pass filter 530, and a multiplexer (MUX) 540.

The low pass filter 510 passes therethrough a tag signal having a frequency of about 848 KHz and the low pass filter 530 passes therethrough a tag signal having a frequency of about 424 KHz by being passed through the low pass filter 510 and the down sampler 520. The MUX 540 selectively outputs signals passed through the filter according to the subcarrier frequency of the tag signal input through the low pass filter 530.

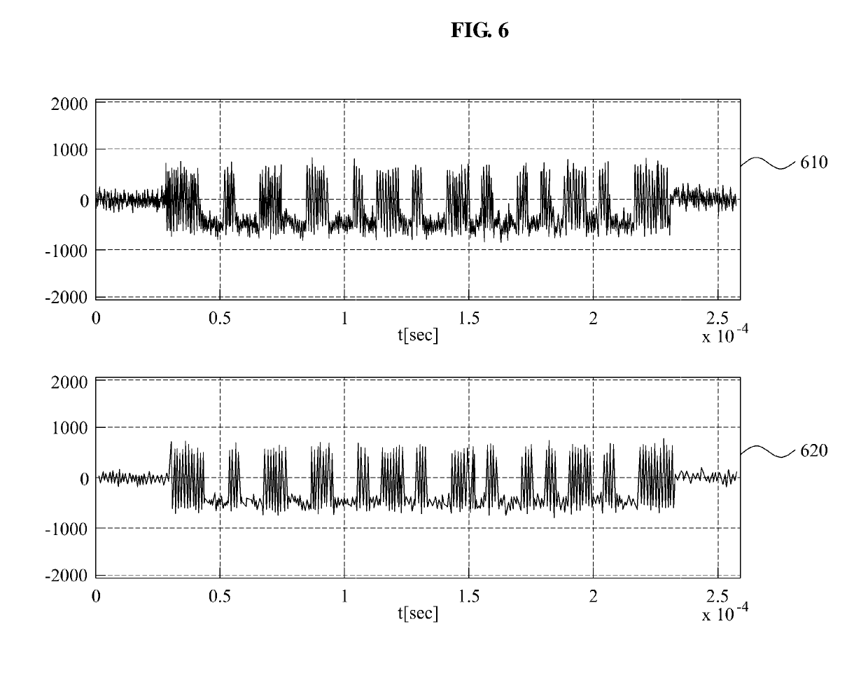

FIG. 6 shows graphs illustrating a tag signal which is the 848 KHz Manchester subcarrier signal output by the 2-stage decimation filter 411.

Referring to FIG. 6, a first graph 610 denotes a tag signal being input to the 2-stage decimation filter 411. A second graph 620 denotes the input signal being low-passed and output.

The rectangular waveform remover 412 of FIG. 4 is input with the tag signal output from the 2-stage decimation filter 411 and removes, from the tag signal, a rectangular pulse not containing a subcarrier cycle during the first half-period of a symbol.

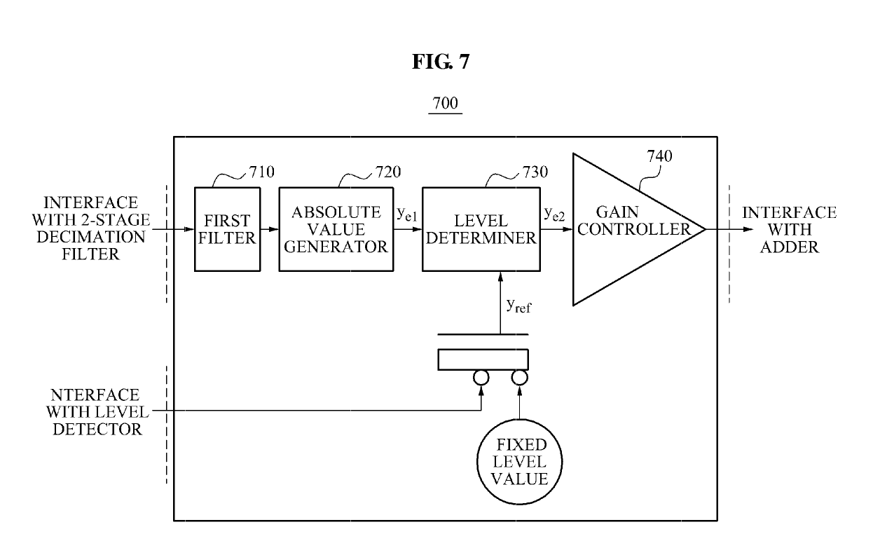

FIG. 7 is a diagram illustrating a structure of a rectangular waveform remover 700 of an RFID reader digital demodulation apparatus.

Referring to FIG. 7, the rectangular waveform remover 700 includes a first filter 710, an absolute value generator 720, a level determiner 730, and a gain controller 740.

The first filter 710 may be a subcarrier cycle type filter. The first filter 710 is adapted to remove the rectangular pulse within the first half-period of the symbol contained in the received tag signal, the first half-period not containing the subcarrier cycle having a selected period within a second half-period of the symbol.

The absolute value generator 720 may generate an absolute value using the tag signal from which the rectangular pulse is removed.

The level determiner 730 may improve performances of signal restoration and symbol determination by removing a low noise contained in the signal output from the absolute value generator 720. For example, the level determiner 730 operates to allow output of only a level signal having a level value greater than a reference level value input through level extractor 413 of FIG. 4 or than a fixed level value predetermined by a user according to circumstances.

In addition, as shown in Equation 1 below, the level determiner 730 may remove the low noise less than a reference level value Y_{ref} from a tag signal Yₑ₁(t) to output the low-noise-removed signal.

$${y}_{e 2} ( t ) = \{ \begin{matrix}{y}_{e 1} ( t ) , & {y}_{e 1} \geq {y}_{ref} \\ 0 , & {y}_{e 1} < {y}_{ref}\end{matrix} \qquad [ Equation 1 ]$$

The first filter 710 may remove the rectangular pulse not containing the subcarrier cycle having a selected period, by adjusting a period of width Ta.

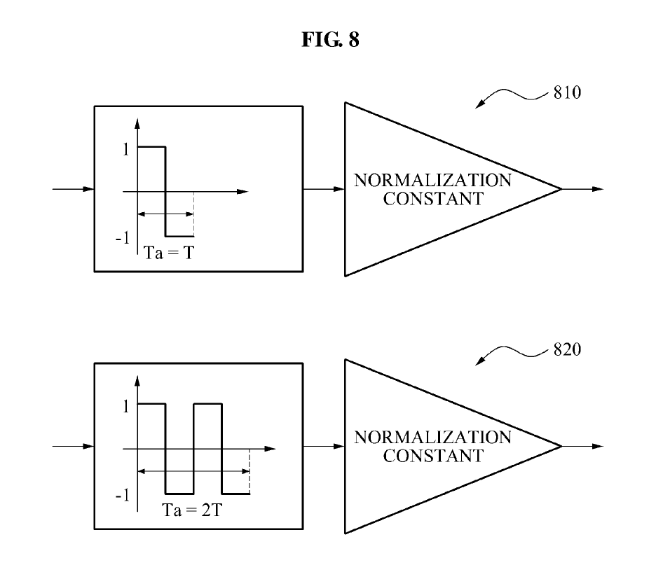

FIG. 8 is a diagram illustrating two rectangular waveform removers having different pulse widths.

Referring to FIG. 8, assuming that ‘T’ denotes one period of the subcarrier cycle, the first filter 710 may have a period 810 equal to ‘T’ or a period 820 twice as much as ‘T.’ The period may be decided according to a user's purpose. For example, when the received tag signal includes 4 subcarriers, the first filters of the two period types 810 and 820 may be selectively used. When the received tag signal includes two subcarriers, the first filter having the period of ‘T’ may only be used.

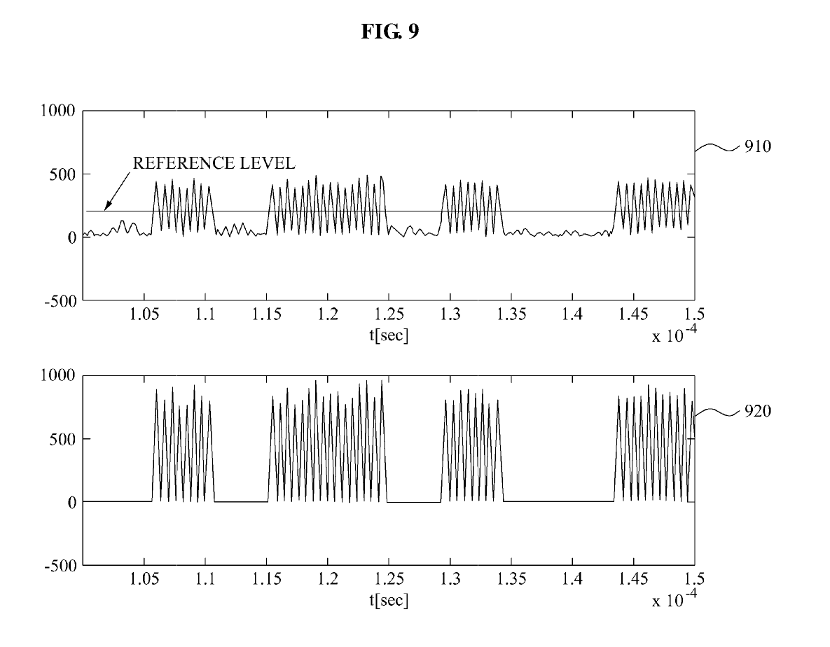

FIG. 9 shows graphs illustrating a tag signal 910 which is a Manchester subcarrier signal having four subcarrier cycles output through a rectangular waveform remover.

Referring to FIG. 9, a graph 910 illustrates a tag signal passed through the absolute value generator 720. A graph 920 illustrates the tag signal passed through the absolute value generator 720, the signal from which the low noise is removed using the reference level value by the level determiner 730.

As a signal passed through the rectangular waveform remover 412 and a signal passed through the subcarrier cycle remover 414 are passed through the adder 415 and the low pass filter 416, a first baseband signal is generated. The gain controller 740 is adapted to maintain a high level or a low level of a first baseband signal. The gain controller 740 may operate with a double value of a default operation value or vary the operation value according to circumstances.

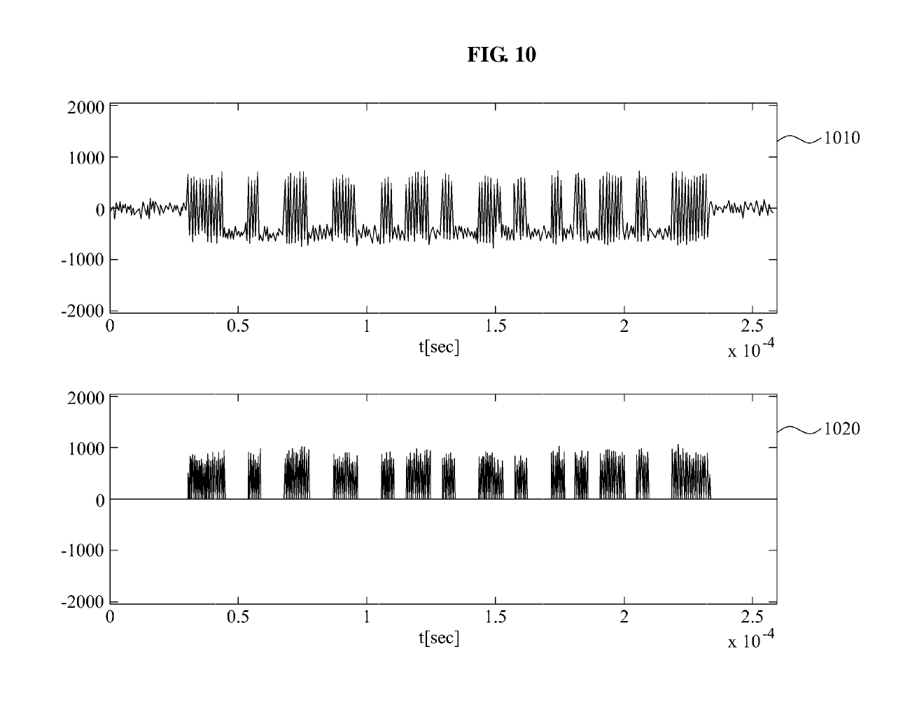

FIG. 10 shows graphs illustrating a tag signal which is a Manchester subcarrier signal having four subcarrier cycles, the signal passed through a 2-stage decimation filter and output through a rectangular waveform remover

A graph above in FIG. 10 illustrates a Manchester subcarrier signal 1010 of about 848 KHz passed through the 2-stage decimation filter. A graph below in FIG. 10 illustrates a tag signal 1020 which is the Manchester subcarrier signal from which a rectangular pulse corresponding to the first half-period of the symbol is removed by the rectangular waveform remover 700. Here, the rectangular waveform remover 700 uses a first filter 710 having the period of width Ta equal to T.

Next, the subcarrier cycle remover 410 of the RFID reader digital demodulation apparatus 400 of FIG. 4 is input with the subcarrier tag signal output from the 2-stage decimation filter 411 and removes the subcarrier cycle within the second half-period of the symbol.

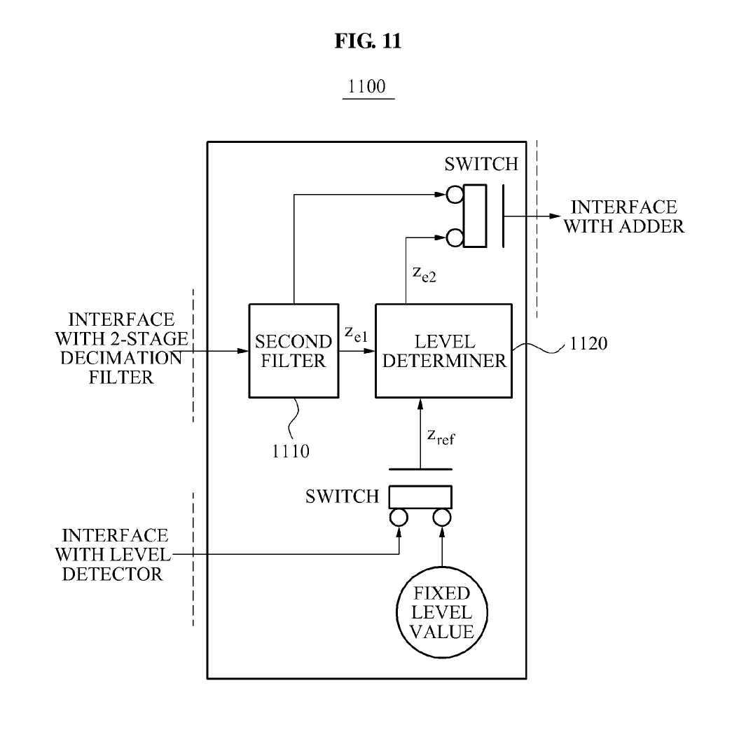

FIG. 11 is a diagram illustrating a structure of a subcarrier cycle remover 1100 of an RFID reader digital demodulation apparatus.

Referring to FIG. 11, the subcarrier cycle remover 1100 includes a second filter 1110 and a level determiner 1120.

The second filter 1110 is a rectangular pulse type filter adapted to remove the subcarrier cycle having a selected period within the second half-period of the symbol contained in the received tag signal.

When the tag signal input to the subcarrier cycle remover 1100 contains a DC offset noise, the signal output through the second filter 1110 of the subcarrier cycle remover 1100 may be distorted due to the DC offset noise, different from when output through the rectangular waveform remover 700. The low noise removal may not be achieved simply by the level determiner as described with Equation 1.

Therefore, the level determiner 1120 of the subcarrier cycle remover 1100 is applicable only when the tag signal input to the subcarrier cycle remover 1100 contains almost no DC offset noise. That is, the level determiner 1120 is dispensable.

When the level determiner 1120 is used in the subcarrier cycle remover 1100, the level determiner 1120 may allow output of only a signal having a level value less than a reference value input through the level extractor 413 or than a fixed level value predetermined by a user according to circumstances.

Also, as shown in Equation 2 below, the level determiner 1120 may remove a low noise greater than a reference level value Z_{ref} from a tag signal Zₑ₁(t) to output the low-noise-removed signal.

$${Z}_{e 2} ( t ) = \{ \begin{matrix}{Z}_{e 1} ( t ) , & {Z}_{e 1} \leq {Z}_{ref} \\ 0 , & {Z}_{e 1} > {Z}_{ref}\end{matrix} \qquad [ Equation 2 ]$$

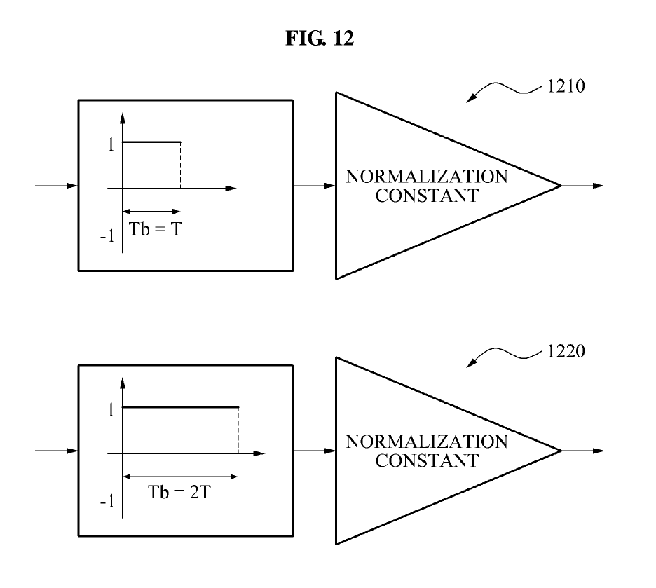

FIG. 12 is a diagram illustrating two subcarrier cycle removers having different pulse widths.

Referring to FIG. 12, assuming that ‘T’ denotes one period of the subcarrier cycle, the second filter 1110 may have a period 1210 equal to ‘T’ or a period 1220 twice as long as ‘T.’ The period of the second filter 1110 may be decided according to a user's purpose. For example, when the received tag signal includes 4 subcarriers, the second filters 1110 of the two period types 1210 and 1220 may be selectively used. When the received tag signal includes two subcarriers, the second filter having the period 1210 equal to ‘T’ may only be used. Here, the period of the second filter 1110 used in the subcarrier cycle remover 1100 and the period of the first filter 710 used in the rectangular waveform remover 700 need to be equal.

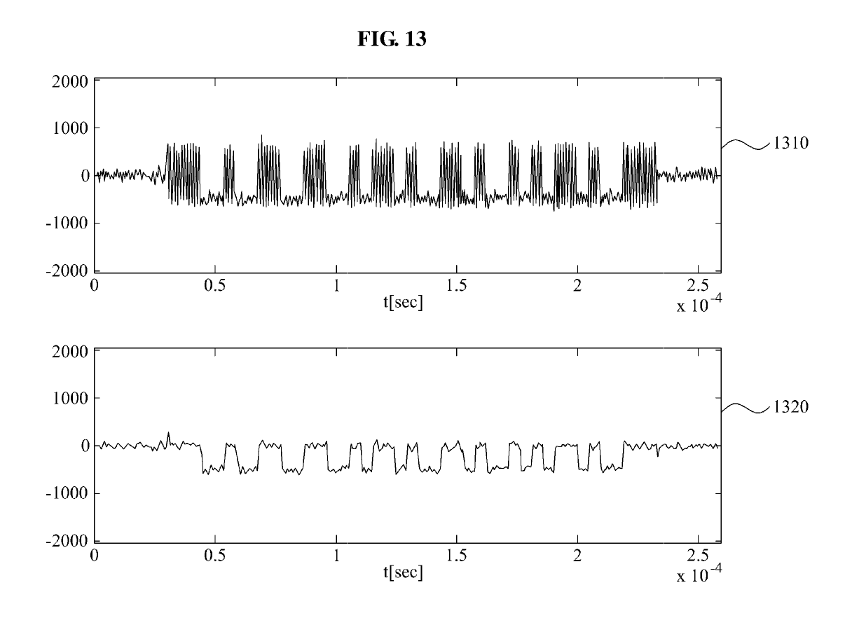

FIG. 13 shows graphs illustrating a tag signal which is a Manchester subcarrier signal having four subcarrier cycles, which is passed through a 2-stage decimation filter and output through a subcarrier cycle remover.

In FIG. 13, a first graph 1310 illustrates a Manchester subcarrier signal of about 848 KHz passed through the 2-stage decimation filter 4110. A second graph 1320 illustrates a tag signal which is the output Manchester subcarrier signal from which the subcarrier cycle corresponding to the second half-period of the symbol is removed by the subcarrier cycle remover 1100. Here, the subcarrier cycle remover 1100 uses the second filter 1110 having the period of width Tb equal to T.

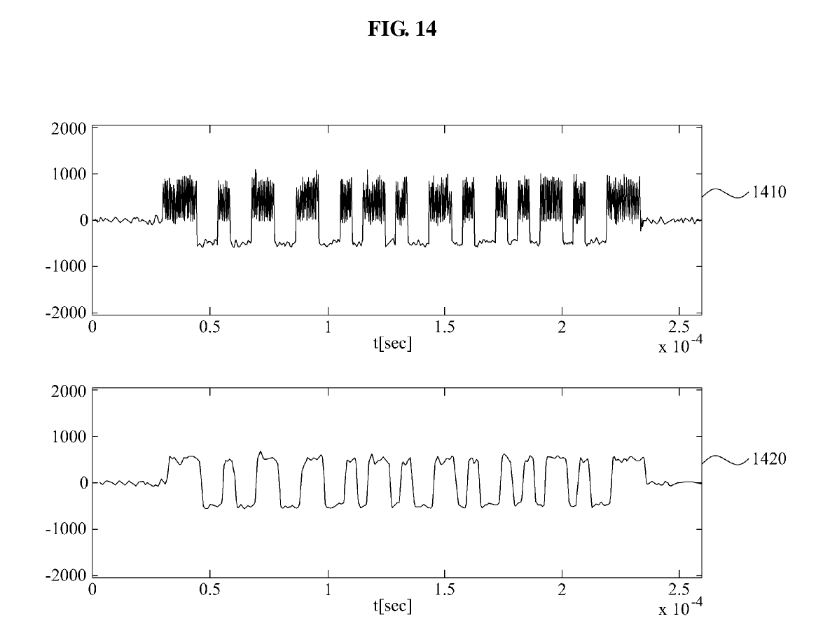

FIG. 14 shows graphs illustrating a first baseband signal.

Referring to FIG. 14, the adder 415 may obtain a sum signal 1410 of a signal output from the rectangular waveform remover 410 and a signal output from the subcarrier cycle remover 414. The subcarrier digital demodulator 410 may generate a first baseband signal 1420 by passing the added signal through the low pass filter 416.

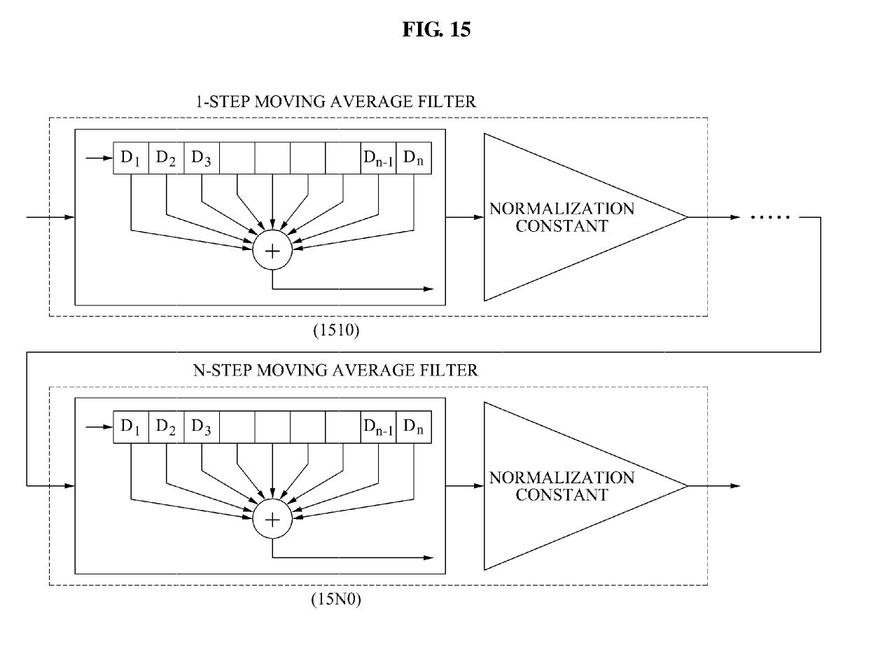

FIG. 15 is a diagram illustrating a structure of a low pass filter 416 embodied by a cascade moving average filter.

Referring to FIG. 15, the low pass filter 416 may be a cascade moving average filter 1510 to 15N0. The low pass filter 416 may be implemented without a filter coefficient multiplier. Although the cascade moving average filter is used for the low pass filter 416 in this embodiment, various other types of low pass filters may be applied.

Next, the DC offset remover 420 of the RFID reader digital demodulation apparatus 400 of FIG. 4may remove a DC offset noise from the tag signal from which the subcarrier cycle is removed, using a matched filter. To remove the DC offset noise contained in the first baseband signal, the DC offset remover 420 may include a matched filter 421 having the same configuration as a Manchester basic signal, an absolute value generator 422, a peak position extractor 423, and a basic signal regenerator 424.

The matched filter 421 is adapted to reduce affects of noises added during transmission from a receiver of a digital communication system. Filter factors are matched with characteristics of a known input signal such that a maximum value is output when the corresponding signal is input.

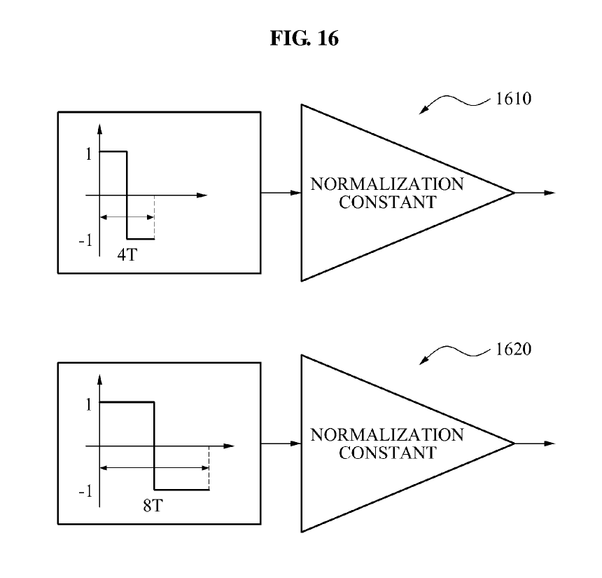

FIG. 16 is a diagram illustrating a structure of a matched filter 421 constituting a DC offset remover of an RFID reader digital demodulation apparatus.

Referring to FIG. 16, the matched filter 421 has the same configuration as the Manchester basic signal from which the subcarrier cycle is removed, such that the DC offset noise in the tag signal is effectively removed even when fluctuation is caused by the DC offset noise. For example, the matched filter 421 may be implemented by a filter used when the Manchester basic signal has two subcarrier cycles as in an upper diagram 1610 and a filter used when the Manchester basic signal has four subcarrier cycles as in a lower diagram 1620.

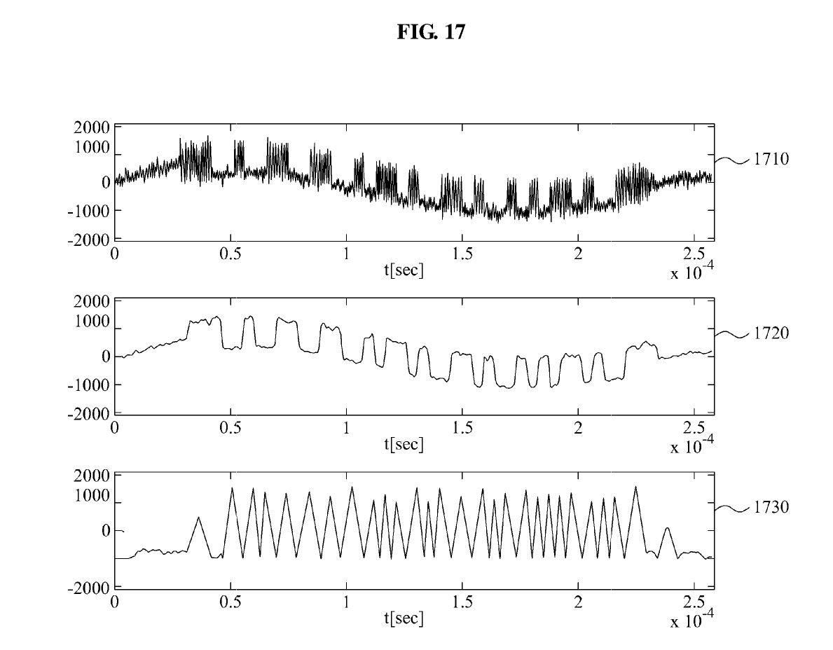

FIG. 17 shows graphs illustrating a tag signal containing a DC offset noise, output through respective units.

Referring to FIG. 17, when the tag signal containing a DC offset noise is input to the RFID reader digital demodulation apparatus 400, the tag signal is passed through the digital demodulator including the subcarrier cycle remover 414 and the rectangular waveform remover 412 and also passed through the matched filter 421 of FIG. 16 and the absolute value generator 422 of FIG. 4.

A graph 1710 illustrates the Manchester subcarrier signal including four subcarrier cycles of about 848 KHz, which are distorted by the DC offset noise. A graph 1720 illustrates a first baseband signal which is the tag signal distorted by the DC offset noise, the first baseband signal passed through the RFID reader digital demodulation apparatus 400. A graph 1730 illustrates a peak signal which is the first baseband signal output through the matched filter 421 and the absolute value generator 422.

The peak signal is resistant against the DC offset noise as can be understood from FIG. 17. Here, the DC offset remover 420 generates the peak signal at a position in the first baseband signal, where transition occurs every time.

The peak position detector 423 extracts a peak position by being input with the peak signal, and generates an edge clock corresponding to the peak position.

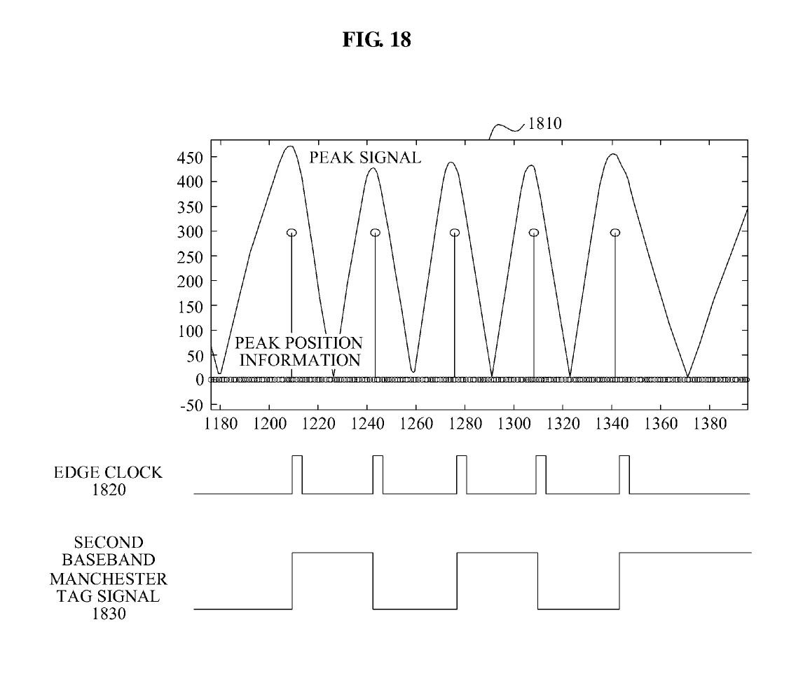

FIG. 18 shows graphs respectively illustrating a peak signal, an edge clock, and a second baseband signal.

Referring to FIG. 18, a graph 1810 illustrates a peak signal generated in a position where transition occurs every time in a first baseband signal. A graph 1820 illustrates an edge cock generated by the peak position detector 423 using the peak signal. A graph 1830 illustrates a second baseband signal output from the basic signal regenerator 424 input with the edge clock.

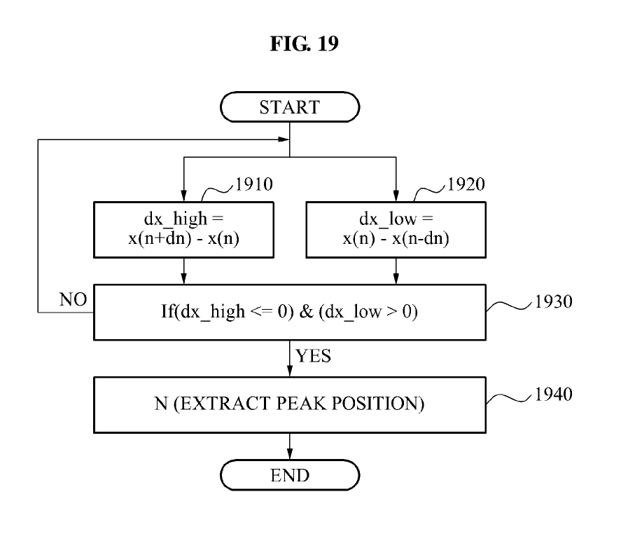

FIG. 19 is a flowchart illustrating an algorithm to extract a peak position through a peak position detector.

Referring to FIG. 19, the peak position detector 423 detects the peak position at a position x(n) of the peak signal. In operations 1910 and 1920, the peak position detector 423 determines whether conditions for generating a peak point where a positive slope turns to a negative slope are satisfied, using dx_high and dx_low. Here, ‘dn’ denotes a natural number and, when dn=1, it means a sample value of a very previous sample and, when dn=2, it means a sample value of a second previous sample from a present sample.

In operations 1930 and 1940, when dx_high≦0 and dx_low>0, the peak position detector 423 extracts the corresponding position as the peak position. Here, the peak position detector 423 extracts an ‘n’ value of the corresponding position.

Even though the peak signal contains a local peak noise signal, the local peak noise may be prevented by setting ‘dn’ to a sample value greater than 1.

The peak position detector 423 generates an edge clock using the extracted peak information. Next, the basic signal regenerator 424 is input with the edge clock and thereby generates the second baseband signal 1830 of a transistor-transistor-logic (TTL) level, from which the DC offset noise is removed.

Next, the symbol determiner 440 is input with the second baseband signal of the TTL level, from which the DC offset noise is removed, and extracts tag information contained in the tag signal. Thus, the tag information of the tag signal may be more accurately detected.

The operation of the RFID reader digital demodulation apparatus according to the embodiments of the present invention has been described in detail with respect to the Manchester subcarrier signal including four subcarrier cycles. However, the RFID reader digital demodulation apparatus is also applicable to the Manchester subcarrier signal including two subcarrier cycles.

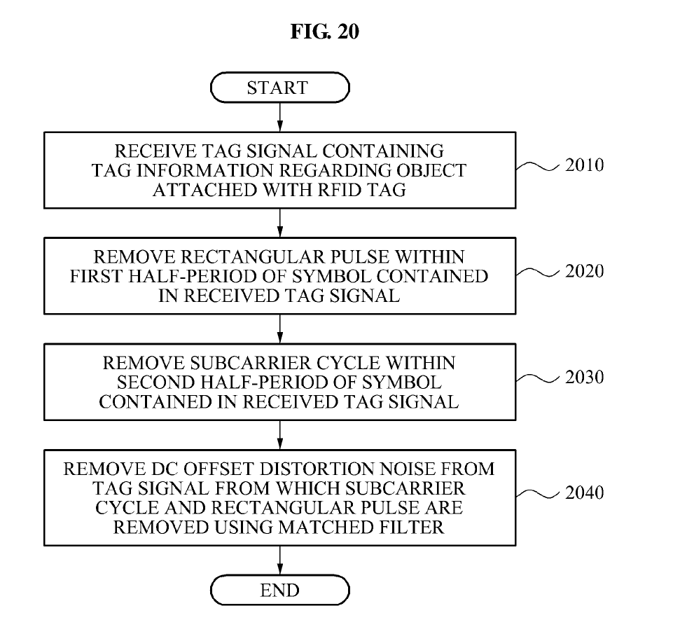

FIG. 20 is a flowchart illustrating a method of RFID reader digital demodulation, according to an embodiment of the present invention.

In operation 2010, the RFID reader digital demodulation apparatus 400 receives the tag signal containing the tag information regarding the object attached with the RFID tag. The RFID reader digital demodulation apparatus 400 may receive the tag signal from the A/D converter 430.

In operation 2020, the RFID reader digital demodulation apparatus 400 removes the rectangular pulse within the first half-period of the symbol contained in the received tag signal. The rectangular waveform remover 412 of the RFID reader digital demodulation apparatus 400 may remove the rectangular pulse not containing the subcarrier cycle during the first half-period of the received tag signal. Here, the level determiner 730 of the rectangular waveform remover 700 may remove the low noise of the tag signal from which the rectangular pulse is removed, using the reference level value extracted from the level extractor 413 and the predetermined fixed level value.

In operation 2030, the RFID reader digital demodulation apparatus 400 removes the subcarrier cycle within the second half-period of the symbol contained in the received tag signal. The subcarrier cycle remover 414 of the RFID reader digital demodulation apparatus 400 may remove the subcarrier cycle having the selected period within the second half-period of the symbol contained in the received tag signal. In addition, the level determiner 1120 of the subcarrier cycle remover 1100 may remove the low noise of the tag signal from which the subcarrier cycle is removed, using the reference level value extracted from the level extractor 413 and the predetermined fixed level value.

In operation 2040, the RFID reader digital demodulation apparatus 400 removes the DC offset noise from the tag signal from which the subcarrier cycle and the rectangular pulse are removed, using the matched filter 421. For example, the RFID reader digital demodulation apparatus 400 may match the tag signal with the characteristics of the tag signal from which the subcarrier cycle and the rectangular pulse are removed by the matched filter 421, and may output the matched tag signal. Next, the absolute value generator 422 of the DC offset remover 420 may generate the absolute value with respect to the output tag signal and then outputs the absolute value. The peak position detector 423 of the DC offset remover 420 may detect the peak position of the tag signal using the output absolute value. The basic signal regenerator 424 of the DC offset remover 420 regenerates the second baseband signal of the TTL level, from which the DC offset noise is removed, using the detected peak position.

The symbol determiner 440 decodes the tag signal demodulated by the subcarrier digital demodulator 410, thereby extracting the tag information.

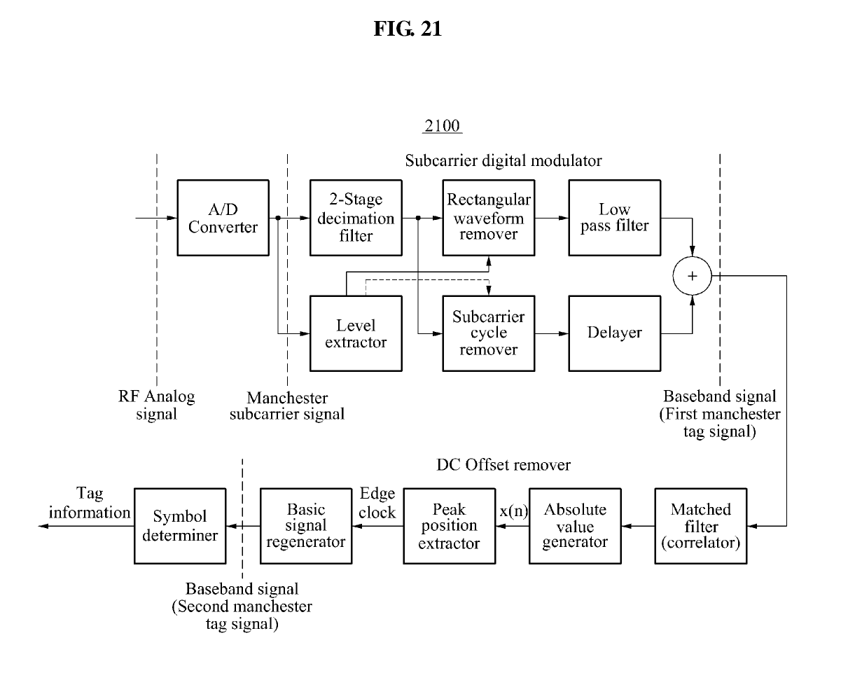

FIG. 21 is a diagram illustrating a structure of a passive RFID reader digital demodulation apparatus with respect to a Manchester subcarrier signal, according to another embodiment of the present invention.

Referring to FIG. 21, an RFID reader digital demodulation apparatus 2100 is similarly configured to the RFID reader digital demodulation apparatus 400 of FIG. 4. However, the RFID reader digital demodulation apparatus 2100 is distinctive in that, for generation of a first baseband signal, a low pass filter is disposed before an adder and after a rectangular waveform remover, and a delayer is additionally provided after a subcarrier cycle remover.

Here, the delayer adjusts starting times of a low level and a high level of a pulse to generate the first baseband signal considering that a delay is induced as the tag signal is passing through the low pass filter after the rectangular waveform remover.

That is, the subcarrier digital demodulator structure for generation of the first baseband signal is applicable to both the RFID reader digital demodulation apparatus 400 and the RFID reader digital demodulation apparatus 2100.

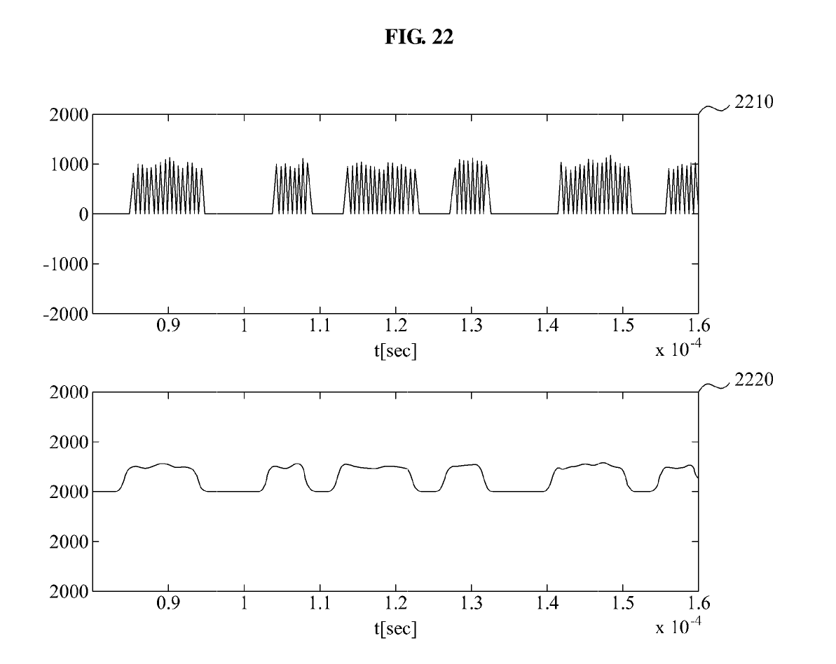

FIG. 22 shows graphs illustrating a tag signal output from the passive RFID reader digital demodulation apparatus of FIG. 21.

In FIG. 22, a graph 2210 illustrates the tag signal passed through the rectangular waveform remover and a graph 2220 illustrates the tag signal passed through the low pass filter.

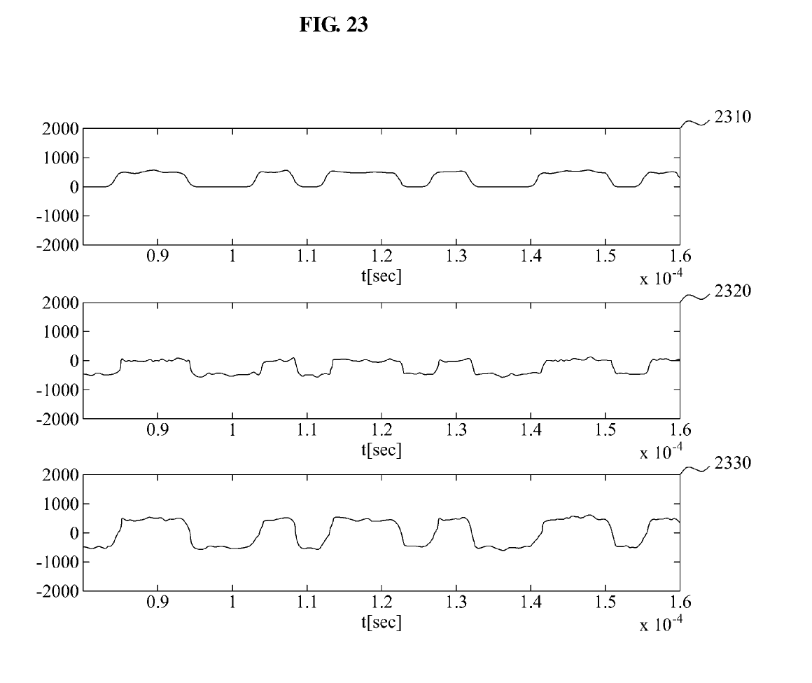

FIG. 23 shows graphs illustrating the first baseband signal output from the passive RFID reader digital demodulation apparatus of FIG. 21.

In FIG. 23, a graph 2310 illustrates the tag signal passed through the rectangular waveform remover and the low pass filter. A graph 2320 illustrates the tag signal passed through the subcarrier cycle remover and the delayer. A graph 2330 illustrates the first baseband signal generated from those two tag signals by the adder.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A radio frequency identification (RFID) reader digital demodulation apparatus comprising:
a subcarrier digital demodulator to receive a tag signal containing tag information regarding an object attached with an RFID tag, to remove a rectangular pulse within a first half-period of a symbol contained in the received tag signal, and to remove a subcarrier cycle within a second half-period; and
a direct current (DC) offset remover to remove DC offset noise from the tag signal from which the subcarrier cycle is removed, using a matched filter.

2. The RFID reader digital demodulation apparatus of claim 1, wherein the subcarrier digital demodulator comprises:
a rectangular waveform remover to remove a rectangular pulse not containing the subcarrier cycle within the first half-period of the symbol contained in the received tag signal; and
a subcarrier cycle remover to remove the subcarrier cycle within the second half-period of the symbol contained in the received tag signal.

3. The RFID reader digital demodulation apparatus of claim 2, wherein the subcarrier cycle remover comprises:
a rectangular-pulse-type filter to remove the subcarrier cycle having a selected period within the second half-period of the symbol contained in the received tag signal; and
a level determiner to remove a low noise of the tag signal from which the subcarrier cycle is removed, using a reference level value extracted from a level extractor or a selected fixed level value.

4. The RFID reader digital demodulation apparatus of claim 2, wherein the rectangular waveform remover comprises:
a subcarrier-cycle-type filter to remove the rectangular pulse not containing the subcarrier cycle having a selected period within the first half-period of the symbol contained in the received tag signal; and
a level determiner to remove a low noise of the tag signal from which the rectangular pulse is removed, using a reference level value extracted from a level extractor or a selected fixed level value.

5. The RFID reader digital demodulation apparatus of claim 4, wherein the rectangular waveform remover comprises:
an absolute value generator to generate an absolute value using the tag signal from which the rectangular pulse is removed; and
a gain controller to maintain a level of the tag signal output from the level determiner at a high level or a low level of a first baseband signal generated by a low pass filter.

6. The RFID reader digital demodulation apparatus of claim 2, wherein the subcarrier digital demodulator comprises:
an adder to obtain a sum signal of a signal output from the subcarrier cycle remover and a signal output from the rectangular waveform remover;
a low pass filter to generate a first baseband signal from a signal output from the adder; and
a level extractor to extract a reference level value in a preamble section of the received tag signal.

7. The RFID reader digital demodulation apparatus of claim 6, wherein the low pass filter has a structure of a cascade moving average filter.

8. The RFID reader digital demodulation apparatus of claim 6, wherein the level extractor supplies the extracted reference level value to the subcarrier cycle remover and the rectangular waveform remover.

9. The RFID reader digital demodulation apparatus of claim 1, wherein the subcarrier digital demodulator comprises a 2-step decimation filter adapted to remove white Gaussian noise from the received tag signal.

10. The RFID reader digital demodulation apparatus of claim 1, wherein the DC offset remover comprises:
a matched filter to match the tag signal with characteristics of the tag signal and output the matched tag signal;
an absolute value generator to generate an absolute value with respect to the output tag signal and output the absolute value;
a peak position detector to detect a peak position of the tag signal using the output absolute value; and
a regenerator to regenerate a second baseband signal with a transistor-transistor-logic (TTL) level, the second baseband signal from which the DC offset noise is removed, using the detected peak position.

11. The RFID reader digital demodulation apparatus of claim 10, wherein the matched filter has a Manchester basic signal form.

12. The RFID reader digital demodulation apparatus of claim 10, wherein the DC offset remover generates a peak signal from which DC offset noise is removed, using the matched filter and the absolute value generator.

13. The RFID reader digital demodulation apparatus of claim 10, wherein the peak position detector generates an edge clock using the detected peak position.

14. The RFID reader digital demodulation apparatus of claim 1, further comprising a symbol determiner to extract the tag information by decoding the tag signal demodulated by the subcarrier digital demodulator.

15. A radio frequency identification (RFID) reader digital demodulation method comprising:
receiving a tag signal containing tag information regarding an object attached with an RFID tag;
removing a rectangular pulse within a first half-period of a symbol contained in the received tag signal;
removing a subcarrier cycle within a second half-period; and
removing DC offset noise from the tag signal from which the subcarrier cycle and the rectangular pulse are removed, using a matched filter.

16. The RFID reader digital demodulation method of claim 15, wherein the removing of the subcarrier cycle within the second half-period of the symbol comprises:
removing the subcarrier cycle having a selected period within the second half-period of the symbol contained in the received tag signal; and
removing a low noise of the tag signal from which the subcarrier cycle is removed, using a reference level value extracted from a level extractor or a selected fixed level value.

17. The RFID reader digital demodulation method of claim 15, wherein the removing of the rectangular pulse within the first half-period of the symbol comprises:
removing the rectangular pulse not containing the subcarrier cycle having a selected period within the first half-period of the symbol contained in the received tag signal; and
removing a low noise of the tag signal from which the rectangular pulse is removed, using a reference level value extracted from a level extractor or a selected fixed level value.

18. The RFID reader digital demodulation method of claim 15, further comprising:
adding the tag signal from which the subcarrier cycle is removed to the tag signal from which the rectangular pulse is removed;
generating, from the added signal, a first baseband signal using a low pass filter having a structure of a cascade moving average filter; and
extracting a reference level value in a preamble section of the received tag signal.

19. The RFID reader digital demodulation method of claim 15, wherein the removing of the DC offset noise from the tag signal from which the subcarrier cycle is removed comprises:
matching the tag signal with characteristics of the tag signal using a matched filter having a Manchester basic signal form;
generating an absolute value with respect to the matched tag signal;
detecting a peak position of the tag signal using the generated absolute value; and
regenerating a second baseband signal with a TTL level, the second baseband signal from which the DC offset noise is removed, using the detected peak position.

20. A radio frequency identification (RFID) reader digital demodulation apparatus generating a baseband signal from which a subcarrier cycle is removed, using a subcarrier digital demodulator adapted to receive a tag signal containing tag information regarding an object attached with an RFID tag, to remove a rectangular pulse within a first half-period of a symbol contained in the received tag signal, and to remove the subcarrier cycle within a second half-period.
